(19) United States
(12) Patent Application Publication
(10) Pub. No.: US 2020/0374387 A1
(43) Pub. Date: Nov. 26, 2020

(54) METHOD OF ENHANCING A HEARING AID SYSTEM

(71) Applicant: LOMBARD LTD. LLC, SKILLMAN, NJ (US)

(72) Inventor: NIGEL GARDNER, SKILLMAN, NJ (US)

(21) Appl. No.: 16/879,234

(22) Filed: May 20, 2020

Related U.S. Application Data
(60) Provisional application No. 62/850,764, filed on May 21, 2019.

(51) Int. Cl. H04M 1/725; H04M 1/60; H04R 25/00

(52) U.S. Cl. CPC H04M 1/72591; H04R 25/554; H04R 25/43; H04M 1/6066

(57) ABSTRACT

A method and system including a removable antenna configured to operatively associate with a smart device so as to receive and transmit magnetic signals broadcast via an induction loop sound source to a hearing aid device, head phone or ear bud by way of an associated smart device.

### BACKGROUND OF THE INVENTION

### Field of the Invention

The present invention relates to hearing aid systems and, more particularly, to a method of enhancing a non-T-coil enabled hearing aid system.

### Description of Related Art

Telecoil or “t-coil” technology is a common feature on conventional hearing aids. Originally used to hear better on the telephone, the t-coil has been used in hearing aids to enhance hearing in difficult listening environments. The t-coil is a small copper coil in a hearing aid that functions as a wireless antenna and can link to a sound system or public address (PA) system, delivering customized sound to the hearing aid wearer within a loop system.

Many hearing aids are not equipped with a t-coil antenna that would otherwise allow the wearer to receive an induction loop signal which is advantageous for hearing aid systems. In addition, improvements in hearing aids have reduced the size of the hearing aid to a size which fits in the canal (ITC) and is not seen during use by the wearer. The ITC hearing aid is too small to include a t-coil antenna. Additionally, some people with hearing loss do not have a hearing aid or may have left them elsewhere.

Separate headphones could be used to send an induction loop signal. However, this is not a convenient method to correct the deficiency since if the person is hard of hearing they are usually already wearing a hearing aid, and so it is not convenient to put in a hearing bud as this first requires taking out and securely handling the fragile current hearing aid. In addition, utilizing separate headphones is an additional piece of equipment for the hearing-impaired person to carry around, yet another inconvenient approach. There is currently no other way of sending an induction loop signal via Bluetooth or an equivalent wireless transmission to a hearing aid wearer without the t-coil.

Conventional smartphones include software applications loaded thereon, wherein the application is adapted to adjust the signal through digital signal processing and an equalizer to optimize the sound for the person with hearing loss, thereby maximizing the intelligibility and quality of the audio signal provided to the user. Whereby, the 40 million or more estimated potential users in the USA could benefit from hearing the induction loop broadcast that is increasingly available in public spaces such as theaters, houses of worship and museums. However, electromagnetic noise in the smartphone would not allow a t-coil antenna to be in included in the interior of the smartphone.

It is desirable to provide a method of enhancing a hearing aid system to receive an induction loop signal which is not available to the hearing aid wearer without a t-coil. It is also desirable to enable the induction loop signal to be transmitted to a headphone or ear bud.

### SUMMARY OF THE INVENTION

The present invention allows for an induction loop signal to be picked up and broadcast by a smart device to a person with a non t-coil equipped hearing aid, a headphone or earbud. The method and system of the present invention embodies a removable antenna configured to operatively associate with a smart device so as to receive and transmit magnetic signals broadcast via an induction loop sound source to the hearing aid device by way of the associated smart device.

The method and system of the present invention embodies a removable antenna which can include a plurality of embedded t-coils that pick up a looped signal from a magnetic induction loop source. Since the looped signal is directional, the use of four t-coils enables improved reception. Output from the t-coils is fed to a chipset which then converts an analog signal for output to a smart device. The functionality of the smart device transmits the induction loop signal to a user's hearing aid, headphones or earbuds.

By receiving at the smart device, through the removable antenna, the induction loop signal that is not available to the hearing aid wearer without a T-coil, and providing output through the smart device, such as Bluetooth or equivalent, operatively associated with the antenna, to a hearing aid, headphone, or ear buds, the hard of hearing person is able to receive a clear signal broadcast in a “looped” room.

The invention defined by the present claims will be more fully described by reference to the following drawings.

### BRIEF DESCRIPTION OF THE DRAWINGS

FIG. 1 is an elevation view of an exemplary embodiment of an external antenna case in accordance with the teachings of the present invention;

FIG. 2 is a schematic diagram of a system of the present invention of the present invention provided within the external antenna case shown in FIG. 1.

FIG. 3 is a schematic diagram of a smart device and an application of a smart device which can be used with the system of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

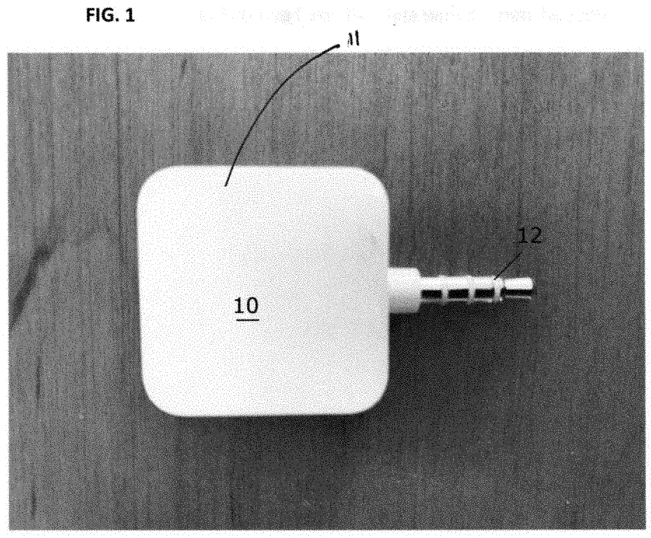

FIG. 1 illustrates antenna system 10 of the present invention. Antenna system 10 can be used for enhancing a hearing, such as with a hearing aid system. Antenna system 10 includes antenna case 11. In one embodiment, antenna case 11 is formed of plastic. Antenna case 11 can be small to provide a streamlined connection with a smart device. For example, antenna case 11 can have of size of about 15×30 mm.

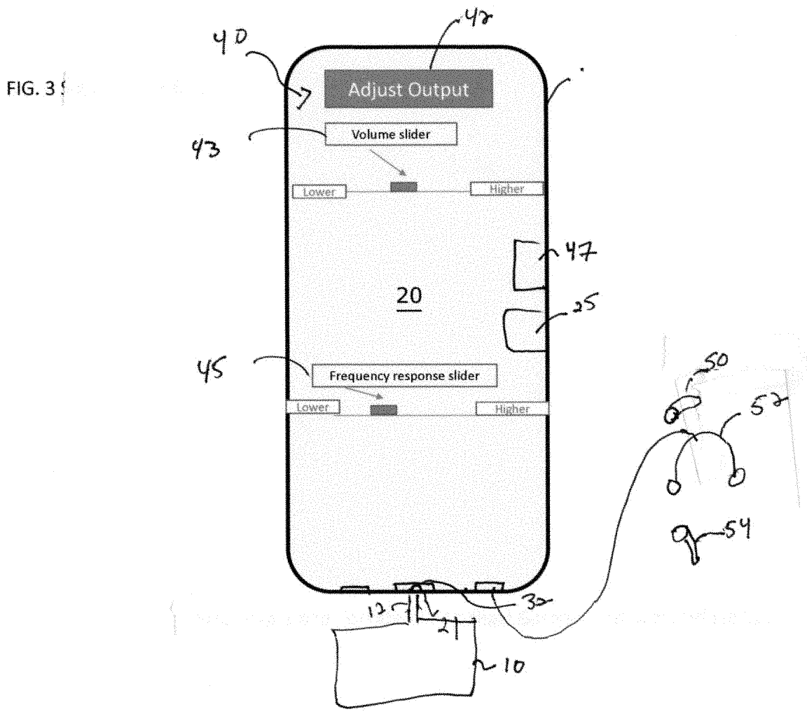

Electrical connector 12 extends from antenna case 11. Electrical connector 12 can be removably connected to smart device 20 as shown in FIG. 3. Electrical connector 12 can be received in input port 21 of smart device 20. Electrical connector 12 can be made to standard specifications used for input port 21 of smart device 20, thereby electrical connector 12 of antenna system 10 can be easily plugged and unplugged into smart device 20. For example, smart device 20 can be an iPhone or Android including input ports and electrical connector is made to be received in the respective input ports of the IPhone or Android.

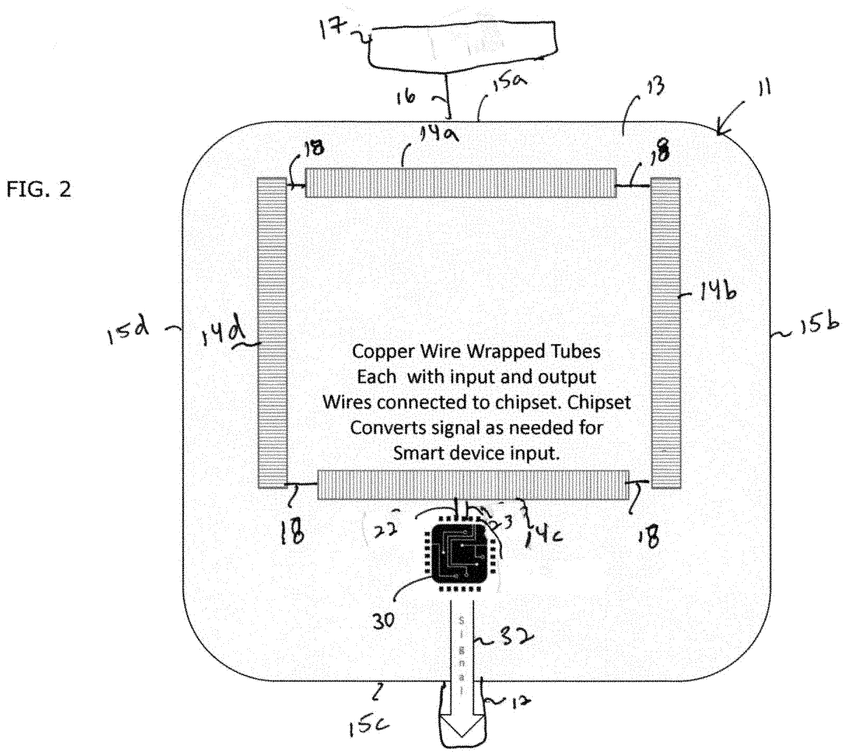

Referring to FIG. 2, a plurality of magnetic loop antennas 14 are positioned in interior 13 of antenna case 11. In one embodiment, four magnetic loop antennas 14a-14d are positioned adjacent each respective side 15a-15d of antenna case 11. Each of magnetic loop antennas 14a-14d are configured to receive a magnetic signal from an induction loop feed from a different direction at respective side 15a-15d of antenna case 11. For example, magnetic signal 16 from an induction loop feed 17 can be received at side 15a of antenna case 11 and transmitted to magnetic loop antenna 14a. Each of magnetic loop antennas 14a-14d can be a t-coil. For example, each of magnetic loop antennas 14a-14d can be a wire wrapped tube. A suitable material for magnetic loop antennas 14a-14d is copper. FIG. 2 shows schematically, the 4 coiled copper tube antenna 10 inside the plastic covering. In certain embodiments, magnetic loop antennas 14a-14d are formed to be slightly smaller than antenna case 11 and embedded inside.

Magnetic loop antennas 14a-14d are connected to one another with antenna coupling members 18. Input wire 22 and output wire 23 of each of magnetic loop antennas 14a-14d connect to chipset 30. Received magnetic signal 16 from magnetic loop antennas 14a-14d is fed to chipset 30 through output wire 23. Chipset 30 converts magnetic signal 16 to analog signal 32 for output to electrical connector 12. Output from electrical connector 12 can be transmitted to smart device 20 when electrical connector 12 is coupled to smart device 20.

FIG. 3 illustrates user interface 40 of adjust output software application 42 running on smart device 20. Adjust output software application 42 can be loaded on smart device 20 so as to be used to control the volume and frequency response of signal 32 being received at smart device 20. User interface 40 can include volume slider 43. Volume slider 43 can be used to control a sound level between a lower and higher value. Frequency response slider 45 can be used to control a frequency output via equalizer 25 of smart device 20 for suiting the listener's hearing. Adjust enhance digital signal processing can be used in adjust output software application 42 to clean up input signal 32 and reduce background noise or distortion.

A method of using the present invention can include the following. Antenna system 10 can be provided to a hearing aid wearer. When the hearing aid wearer is in an area where magnetic signal 16 from induction loop feed 17 is being broadcast, for example as indicated by an international sign, the hearing aid wearer can operatively associate antenna system 10 with smart device 20 by plugging electrical connector 12 into smart device 20 so that a signal received by antenna system 10 can be transferred to smart device 20, wherein smart device 20 functionality can be applied to input signal 32. Given the average age of those with hearing aids the design of antenna system 10 is deliberately simple to plug antenna system 10 into input port 21 of smart device 20.

If not already paired, Bluetooth application 47 on smart device 20 can be enabled and paired with hearing aid 50 that is not T-coil equipped. If antenna system 10 is just being used to receive input signal 32 and Bluetooth is not available on the hearing aid or smart device 20 the user can play the sound signal back using adjust output software application 42 through headphones 52 or earbuds 54 as a listening device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between smart devices or computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software embodied on hardware, firmware or any combination thereof.

Embodiments described herein can be implemented in the form of control logic in hardware or a combination of software and hardware. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “computer” or “processor” may include any hardware system, mechanism or component that processes data, signals or other information. A computer or processor can include a system with a general-purpose central processing unit, multiple processing units, dedicated circuitry for achieving functionality, or other systems. Processing need not be limited to a geographic location, or have temporal limitations. For example, a computer or processor can perform its functions in “real-time,” “offline,” in a “batch mode,” etc. Portions of processing can be performed at different times and at different locations, by different (or the same) processing systems.

It should be understood, of course, that the foregoing relates to exemplary embodiments of the invention and that modifications may be made without departing from the spirit and scope of the present invention.

What is claimed is:

1. A method of enhancing a hearing aid system comprising the steps of:
embodying a removable antenna system configured to operatively associate with a smart device;
receiving magnetic signals at the antenna system, the magnetic signals being broadcast from and induction loop sound source; and
transmitting the received magnetic signals to a hearing aid device, headphone or earbud.

2. The method of claim 1 wherein the removable antenna system comprises a plurality of antennas.

3. The method of claim 1 wherein the antenna system comprises four antennas, each antenna being positioned on a different side of an antenna case.

4. The method of claim 1 wherein the antenna system comprises a plurality of antennas, each of the antennas being formed of a wire coil, adjacent ones of the plurality of antennas being connected to each other.

5. The method of claim 4 wherein the wire coil is formed of copper.

6. The method of claim 1 wherein the antenna system comprises a plurality of antennas, each of the antennas being a t-coil.

7. The method of claim 1 wherein the antenna system comprises an antenna case, a plurality of antennas being positioned at an interior of the antenna case, the plurality of antennas being connected to a chipset, the chipset being connected to an electrical conductor, wherein the electrical conductor is removably received in an input port of the smart device, the magnetic signals are received at the plurality of antennas and transferred from the chipset through the electrical conductor to be received at the smart device.

8. The method of claim 7 wherein the smart device transmits the received magnetic signals to the hearing aid device, headphone or earbud.

9. The method of claim 7 further comprising the step of:
controlling volume and a frequency response of the magnetic signals being received at smart device.

10. The method of claim 9 wherein a user interface on the smart device is used for controlling the volume and frequency response.

11. An antenna system comprising;
an antenna case;
at least one antenna being positioned within the antenna case; and
an electrical conductor, extending from the antenna case, the electrical conductor being configured to be received in an input port of a smart device,
wherein magnetic signals are received at the at least one antenna, the magnetic signals being broadcast from and induction loop sound source; and the smart device transmits the received magnetic signals to a hearing aid device, headphone or earbud.

12. The system of claim 11 comprising four of the antennas, wherein each of the antennas being positioned on a different side of the antenna case and adjacent ones of the plurality of antennas being connected to each other.

13. The system of claim 11 wherein the at least one antenna is formed of a wire coil,

14. The system of claim 13 wherein the wire coil is formed of copper.

15. The system of claim 11 wherein the at least one antenna is a t-coil.

16. The system of claim 11 further comprising a chipset, input and output of each of the at least one antenna being connected to the chipset, the chipset being connected to the electrical conductor, wherein the magnetic signals received at the at least one antenna are transferred from the chipset through the electrical conductor to be received at the smart device.

17. The system of claim 11 further comprising a user interface for adjusting output of the smart device.

18. The system of claim 17 wherein the user interface is used for controlling volume and frequency response of the magnetic signals transmitted from the smart device.

19. The system of claim 11 wherein the antenna case is formed of plastic.
